(19) United States
(12) Patent Application Publication
(10) Pub. No.: US 2015/0158599 A1
(43) Pub. Date: Jun. 11, 2015

(54) ROBOTIC AERIAL VEHICLE DELIVERY SYSTEM AND METHOD

(71) Applicant: Michael Sisko, Windermere, FL (US)

(72) Inventor: Michael Sisko, Windermere, FL (US)

(21) Appl. No.: 14/565,348

(22) Filed: Dec. 9, 2014

Related U.S. Application Data
(60) Provisional application No. 61/914,235, filed on Dec. 10, 2013.

(51) Int. Cl. B64F 1/32; B66B 9/00; B65G 11/02

(52) U.S. Cl. CPC B64F 1/32; B65G 11/023; B66B 9/00

(57) ABSTRACT

A delivery support system accommodates and supports the delivery of packages, parcels and other items via an unmanned aerial vehicle. The system includes components to appropriately position a landing platform at a position and orientation that is away from general traffic areas and thus minimizes the potential for interaction with, and injury to individuals what may be in the area. The system further includes handling accommodations to cause delivered items to be transferred to a location readily accessible by an individual or person. The platform further includes systems to communicate with the unmanned aerial vehicle to aid in the delivery operations, and to confirm appropriate delivery of items.

### BACKGROUND

Many companies' package and ship items, packages, documents or other information (hereafter simply “items”) to fulfill orders from customers. Retailers (whether internet or brick and mortar), wholesalers, businesses, pharmacies, groceries, food service companies and other distributors (hereafter simply “distributors”) typically maintain shipping relationships with the United States Postal Service or various trucking companies in order to direct ship customer orders. Similarly, delivery companies (including the United States Postal Service, trucking companies, Federal Express, DHL, UPS, etc.) coordinate the logistics of product, package or document delivery from virtually any source. A common concern with shipping items involves determining the best method for expediting the delivery of items in the quickest, most cost effective manner, given the nature of the items and the desires of both the distributor and the customer. There is a need for another form of expedited delivery, which engages robotic aerial vehicles to perform the shipping function and can greatly reduce the delivery environmental footprint. Using this method of shipping items to customers, there is a need for shipping and logistical processes tailored to the requirements of the distributors and customers who desire robotic aerial delivery of items.

### SUMMARY

In order to coordinate the delivery of packages and materials utilizing robotic or unmanned aerial vehicles (i.e. “UAVs” or “drones”), a receiving/landing structure is provided to accommodate the operation of the UAVs and facilitate the safe and coordinated delivery of items. The structure may include a platform upon which a UAV could land, or upon which packages could be received when the UAV is carrying out the intended delivery operations. This platform is ideally positioned or placed at a location, which is unlikely to have individuals, pets, or other potential obstructions or incursions in the area. From this general perspective, a first level of safety is achieved based solely upon the positioning and orientation of this platform. In addition, various systems are provided to further coordinate delivery operations. The systems could include mechanical components, electronics, and/or various communication systems. These systems are all coordinated to assist in receiving packages, guiding the UAVs toward the designated platform, communicating necessary information, and avoiding potentially dangerous situations involving unmanned aerial vehicles.

### BRIEF DESCRIPTION OF THE DRAWINGS

Further objects and advantages of the robotic aerial vehicle delivery system and method can be seen with reference to the following description, and drawings in which;

FIG. 1 is a prospective view illustrating the placement of an example platform;

FIG. 2 is a top view of one exemplary platform;

FIG. 3 is a schematic illustration of a particular embodiment;

FIG. 4 is a schematic illustration of yet another embodiment;

FIG. 5 is a schematic view of a third embodiment.

### DESCRIPTION OF THE VARIOUS EMBODIMENTS

In an effort to identify fast, flexible, secure and environmentally beneficial aerial delivery of items, whether to the home or office, a systematic process is provided for locating, targeting, tracking, communicating and delivering items. Generally, the process is determined by a series of protocols, with deference to the FAA (Federal Aviation Administration) Regulatory Standards, GNSS (global navigation satellite systems) and the requirements of ADS-B (automatic dependent surveillance-broadcast), which can enable the robotic aerial vehicle (hereinafter “drone”, “unmanned aerial vehicle” or “UAV”) to carry out delivery of items to a smart building receptacle. The process further coordinates the logistics of distribution, tracking and product delivery. Further, the safety of the general public (and residents or homeowners in particular) is also a primary concern that is further accommodated by the overall delivery process contemplated.

The smart building receptacle can take on many forms, while also meeting several of the goals outlined below. In a preferred embodiment, the receptacle is of a height consistent with, or higher than the building roofline. Generally speaking, the smart building receptacle provides a physical structure to safely accommodate delivery using drones. The smart building receptacle also provides the logistics distribution platform as a receiver and transmitter of information, for identifying its unique location via visual, GPS (global positioning satellite) or electronic transmission to the delivery drone and facilitating the sending or receiving of matching delivery information to verify and process the delivery. The verification process can use many different identification/verification technologies, including UID (unique identification number, numeric, alphanumeric, etc.), UPC (universal product code), linear barcode, matrix barcode, active RFID (radio frequency identification chip), RFID-IR (active radio frequency identification-infrared hybrid), IR (infrared), Optical Locating, Low-Frequency Signpost Identification, Semi-Active RFID, Passive RFID.

In addition to the features outlines above, the smart receptacle further coordinates operation of the drone to insure accurate delivery, using RTLS locating via Steerable Phased Array Antennae, RTLS (real-time locating systems, wireless RTLS tags which may use radio frequency, optical/infrared or acoustic/ultrasound technology), Radio Beacon, US-ID (ultrasound identification), US-RTLS (ultrasonic ranging), UWB (ultra-wideband), WLAN/Wi-Fi (wireless local area network), Bluetooth, Cluster in Noisy Ambience, Bivalent Systems or other means of tracking and tracing a delivery for the purposes of safety, accuracy and convenience and greater information that may include AoA, (angle of arrival), LoS (line of sight), ToA (time of arrival), TDoA (time difference of arrival), DoD (date of delivery), ToF (time of flight), TWR (two-way ranging), SDS-TWR (symmetrical double sided two way ranging), NFER (near field electromagnetic ranging), DS (delivery speed), direction or spatial orientation, wind speed, wind direction, temperature, precipitation, humidity and other helpful weather information (hereinafter simply “delivery”).

A smart platform that blends one or more delivery systems providing delivery information, whether in real time information to computer or mobile device or visually is also provided. Upon a successful drone delivery, the smart building receptacle (hereinafter simply “receptacle”) may also be configured to accommodate the transfer of items between floors or walls in a building, alongside the building within a chute or within the chute of a standalone structure, depending on the installation solution. The receptacle may be securely attached or inserted into an opening in a building's planar partition. The receptacle may be a standalone structure. The receptacle offers a safe, secure and weather resistant means for both the drone delivery sender and receiver. By providing a system and method for safer, faster, accurate, cost effective, environmentally friendly and convenient drone delivery of items, both the seller and consumer satisfaction levels are broadly enhanced.

The receptacle allows for the connectivity flexibility to integrate with existing Internet providers, such as DSL, Cable or Satellite, either via direct connection or Wi-Fi. The Internet connectivity facilitates the transfer of delivery information to the distributor, consumer and the delivery drone. Internet connectivity with Net-centric information access, can also assist with various operations of the drone itself, potentially including location verification, automation-assisted air traffic management, probabilistic weather decision tools, equivalent visual operations, prognostic safety systems, integrated security risk management, delivery itemized statements or shipping transmittals, confirmation of delivery using “electronic signatures” of various types, and redundant communication capabilities (hereafter simply “digital data exchange”) to increase drone landing situational awareness.

Drone landings at the ground level, on public or private property, could seriously endanger pets, pedestrians, automobiles and property, etc. (hereafter simply “incursions”). Generally speaking, drones are moving vehicles and thus necessarily have the potential for collision, property damage and injuries. For example, drones with rotary blade propulsion are spinning at extremely high rates of speed and any incursions coming in contact with the drone could be seriously harmed. Drones with fixed wings, utilizing propeller or other propulsion systems, would also be dangerous for ground level deliveries due to their inbound speed, angle of descent, weight and method of propulsion. In a first embodiment, staging the receptacle at the building roofline, or higher, provides a meaningful margin of safety for drone deliveries and represents a significant incursions collision avoidance system. This margin of safety decreases flight risk and eliminates the need for a drone oriented ground hazard detection, tracking and avoidance system of potential incursions, thereby saving the cost, complexity and inherent risk related to such a hazard mitigation effectiveness system.

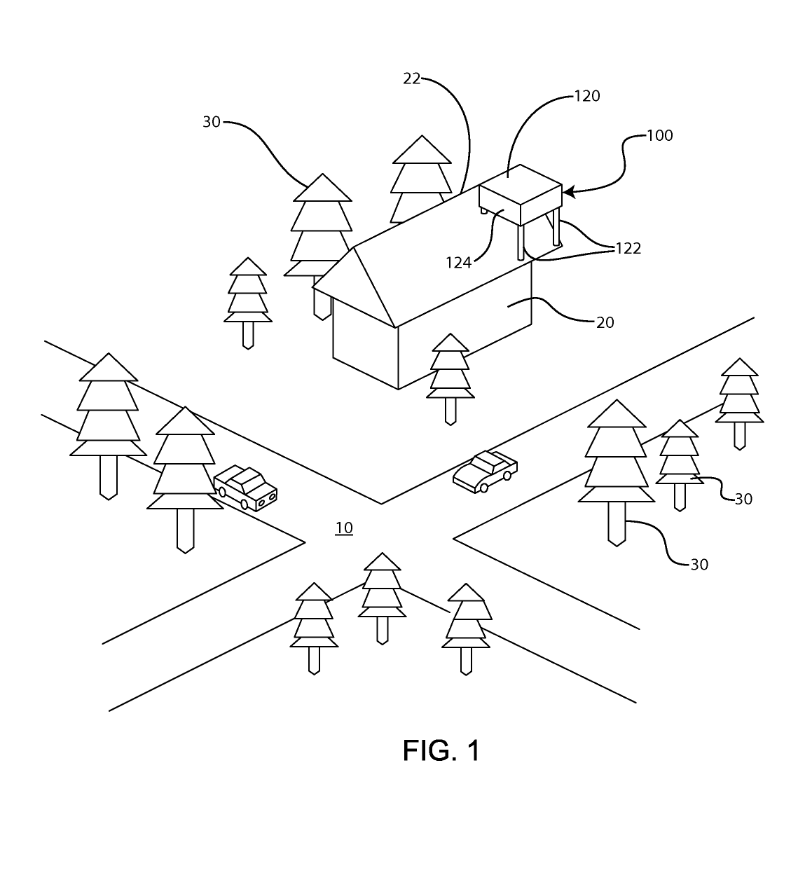

Referring now to FIG. 1, one general perspective view of a potential delivery system implementation is illustrated. More specifically, FIG. 1 illustrates an intersection 10 and a building 20 located on one corner thereof. As further illustrated, the property surrounding building 20 includes a number of trees 30 which are illustrated schematically to provide general context. As mentioned above, one embodiment involves placing or positioning a structure or receptacle 100 above the roofline of building 20. Generally speaking, roofline 22 will typically be away from trees and other interfering items, thus providing easy access for UAVs involved in delivery operations. As generally illustrated, structure 100 includes a platform 120 at an upper portion thereof. It will be easily recognized that such a platform, or landing pad 120 will easily accommodate the operation of a drone. In this particular embodiment, platform 120 is supported by a framework 122, and has a receiving container 124 positioned below.

Assisting the FAA in risk reduction and supporting FAA safety concerns, the preferred embodiment receptacle location of at, or above, the building's roofline substantially simplifies and minimizes the required airspace needing FAA regulatory oversight, by eliminating the below roofline descent and ascent phases of a ground based delivery. Additional accommodation could also assist in the management of air space or flight paths for the drones. For example, requiring the receptacle to be positioned at the rear of a house or building, or to be positioned along alley-ways (where appropriate), could be used to help limit the areas where drones are allowed to fly, minimizing ambient noise and wake turbulence in the more noticeable or populated landing zones.

Additionally, the receptacle's higher location provides a material economic benefit through increasing the speed of delivery and return of the drone to the distributors by eliminating the descent/ascent phase required in a ground level delivery. Further, the receptacle's higher location provides a larger separation minima between any drones, in the event that multiple drones may be delivering items in a neighborhood simultaneously.

The receptacle's higher location likewise provides greater safety for the delivery itself. Ground deliveries, whether left on consumer property, a driveway or sidewalk, would be unsecure and at greater risk from theft or damage due to weather, animal, collision, etc.

The digital data exchange between the drone and the receptacle yields the sending and receiving ability, whereby the drone transmits the delivery data, the receptacle receives the delivery data and returns confirmation data back to the drone. The data confirmation then results in a delivery, either via drone landing or item drop-off. Alternatively, proprietary RFID tags could be attached to the platform, which could be read by the drone to confirm the appropriate delivery location. Using this information, the drone could then complete the delivery process, and carry out additional confirmation tasks. For example, onboard communication techniques could allow the Drone to communicate with a home office, or other locations, confirming that delivery has been completed.

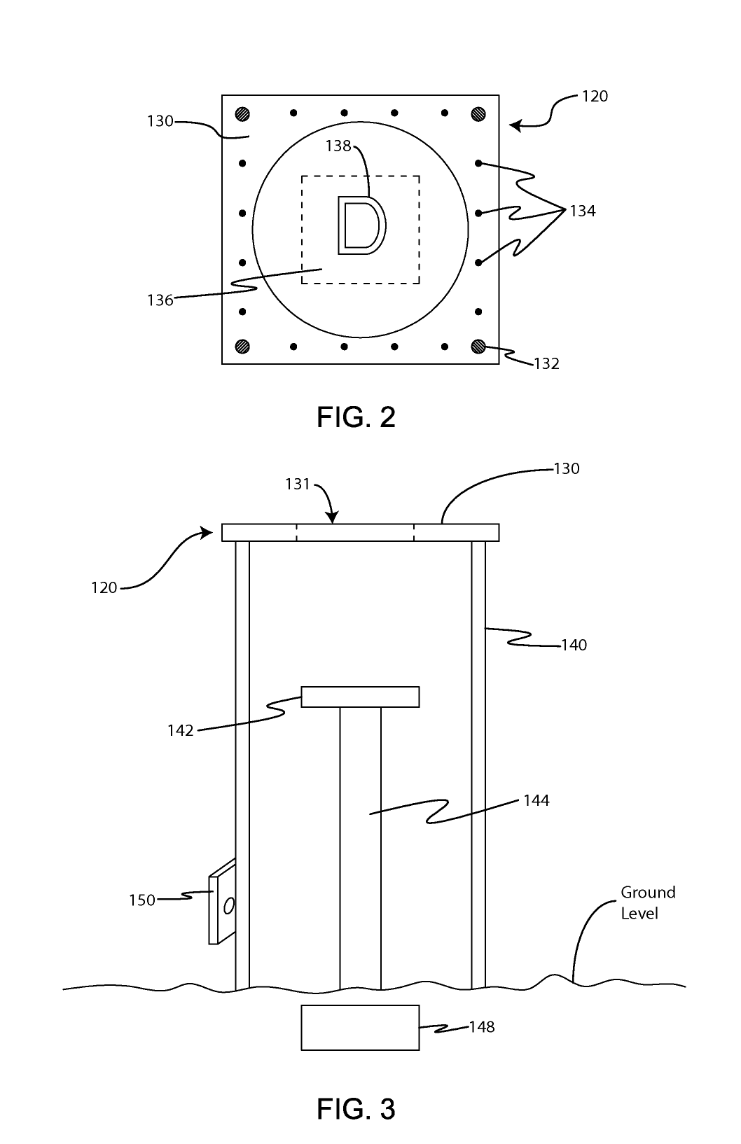

Referring now to FIG. 2, a top view of one embodiment of platform 120 is illustrated. In this particular embodiment, a landing surface 130 is provided to accommodate the interaction with a delivery drone. Here, a number of surrounding corner lights 132 and various marker lights or LED lights 134 are positioned at a parameter of platform 120. Generally positioned in a center portion, a movable platform portion 136 exists. It is contemplated that packages or containers could be placed on movable platform 136 and thus subsequently delivered to other locations. It will be understood that appropriate antennas and marking structures could also be affixed to platform 120, thus accommodating operation of several of the aforementioned communication tools. For example, rf antennas could be appropriately positioned to communicate with a drone when approaching platform 120. Similarly, the above-mentioned RFID tags could be appropriately positioned to cooperate with landing systems, thus verifying the desired delivery operations. Further objects and advantages will clearly be understood by those skilled in the art, some of which are further discussed below.

Generally speaking, the physical structure contemplated for the receptacle provides an appropriate landing pad or landing surface, along with a cooperating delivery bay. Several alternatives are illustrated in the various drawing figures. Again, the landing pad is sized, configured and positioned to appropriately support the drone during landing operations. As would be anticipated, this requires providing the necessary surface area to accommodate the related delivery drone, which is free of obstructions and interfering structures. Further, the receptacle often includes a compartment supporting an opening, fixed or retractable, for receiving the packages. It is anticipated that this receiving structure could include an open space sized large enough to receive packages, but small enough so the opening will not create problems for landing of the drone. Alternatively, the platform could include a door, trap door or hatch that could be opened after the delivered package is placed at a desired location. In this configuration, a cooperating chute would allow the package to be received and transferred to a desired secure location. In some cases, this secure location may simply be a box positioned below the landing pad, while other configurations may involve the movement of packages for greater distances. It is anticipated that the opening or door mechanisms in the platform would be weather tight, or would make accommodations for any weather conditions typically encountered in the location. In yet another option for the delivery system, a lifting system for lowering deliveries through an enclosed chute to the ground level for retrieval and returning the compartment to the top of the chute for the next delivery (e.g. an elevator type system). Naturally, several alternative structures are possible which are capable of accommodating package receipt at a landing pad, and transferring the package to a desired location.

As suggested above, the structure provides a level-landing platform 120 of a dimension large enough to accept drones for vertical landings, takeoffs or delivery drop-offs. As shown in FIG. 2, receptacle LED lighting 134 enhances the landing area and supports visual operational information to the drone. The landing platform will display a centering symbol 138 to denote the primary landing target. Whenever applicable, the landing area will accommodate appropriate weight limits.

In the disclosed embodiment, the receptacle provides a delivery chute for the landing platform that opens to a delivery bay compartment, offering protection from the weather. The delivery bay may be connected to a lifting system for lowering deliveries through an enclosed chute to the ground level for retrieval and returning the compartment to the top of the chute for the next delivery.

Again, certain embodiments contemplate the placement of the receptacle at a location near the top of a home or building. It is certainly possible that other locations are possible. For example, a delivery box could positioned away from the buildings, similar to the way rural mail boxes are placed along roadways. It is contemplated that similar type placement could be implemented in a manner to achieve the above mentioned safety concerns. For example, the landing pad or platform could be positioned at a sufficient height to avoid contact with individuals or pets, and accommodations were provided to bring packages to a more convenient level (e.g. a drop box or an elevator system), such a structure would continued to address many of the concerns mentioned above.

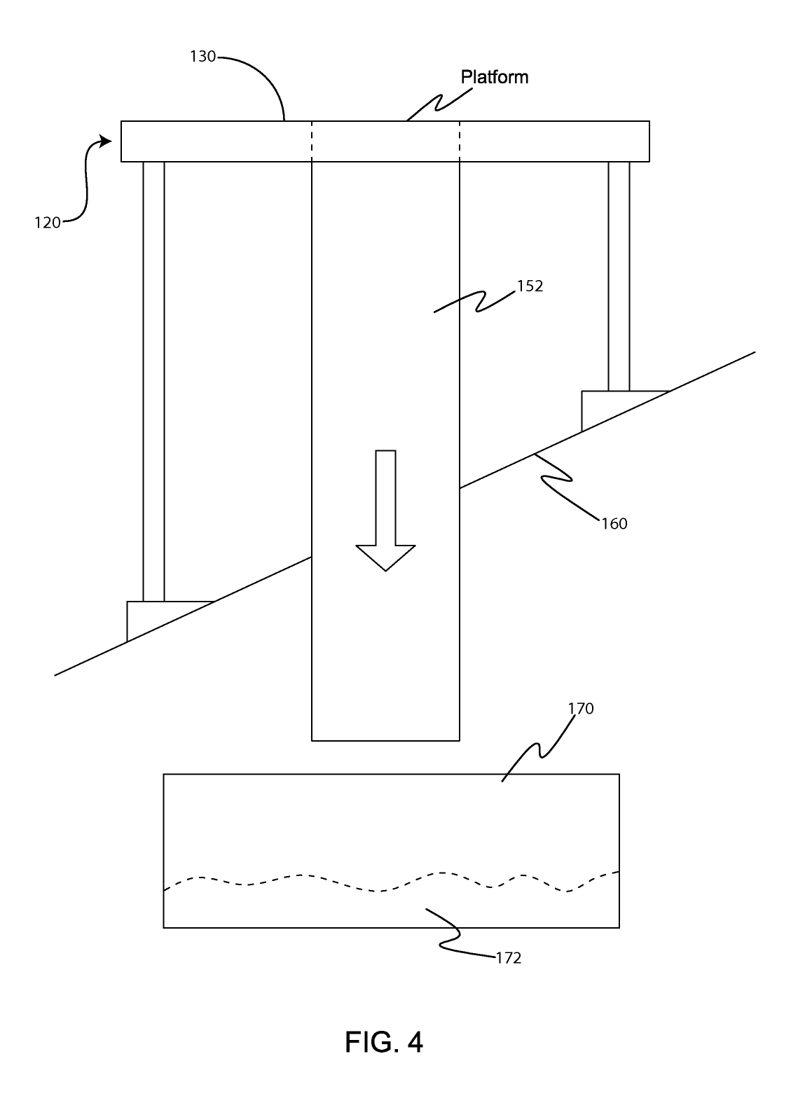

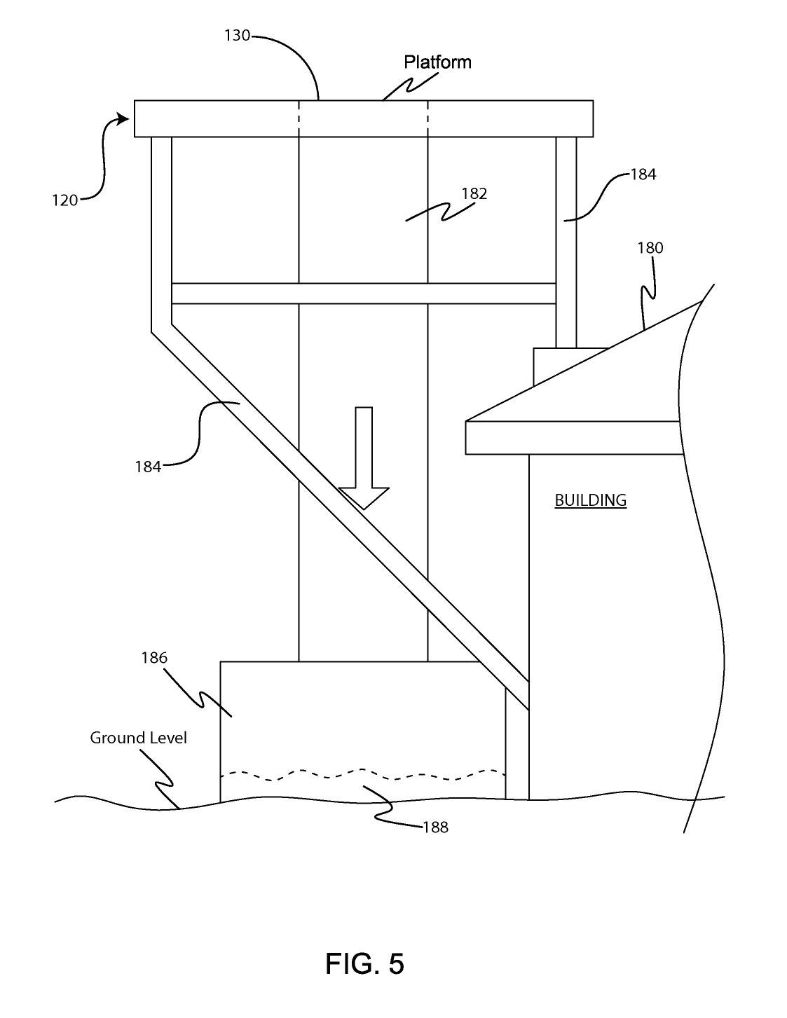

Several variations and additional details are outlined in the attached drawings, which illustrate different concepts and variations. Again, FIG. 1 shows a street view with a receptacle to be attached to the rooftop of a house or building. FIG. 4 illustrates further details for one particular application of the receptacle to the top of the building. Alternatively, a similar structure could be attached adjacent the building, which is shown in FIG. 5. Lastly, one example embodiment of a stand-alone or self standing platform is illustrated in FIG. 3. While each version is generally discussed below, several additional variations and alternatives are possible without departing from the spirit of the concepts described above.

Turning now to FIG. 3, a standalone version of the delivery system is illustrated. In this particular embodiment, platform 120, and its landing surface 130 are supported by a tower-type structure 140. In this particular embodiment, it is contemplated that tower-type structure 140 will be an enclosed or semi-enclosed structure of some type, with a movable platform 142 carried by an elevator shaft 144 contained therein. Naturally, an elevator mechanism 148 will cooperate with elevator shaft 144. In this particular embodiment, it is anticipated that such an elevator mechanism 148 would be positioned below ground level. Movable platform 142, in this context, is anticipated to be substantially similar to movable platform 136 referenced in regard to FIG. 2. Here, a recess or opening 131 in surface 120 is illustrated, which is sized and configured to receive movable platform 142. As will be understood, packages delivered to surface 130 can be carried by movable platform 142 to a lower level, where they may be retrieved by users. As mentioned above, it is contemplated that tower 148 is an enclosed or semi enclosed structure, thus door mechanism 150 is illustrated at a bottom portion thereof, thus allowing user access. To further provide protection from the elements, it is also contemplated that a trapdoor type structure (not shown) could be utilized to close opening 131, when movable platform is refracted to a lower level.

Referring now to FIG. 4, the above-referenced rooftop embodiment is illustrated. Here, platform 120 is positioned above the roofline 160 of a building or residence. In this particular embodiment, a chute 152 is positioned below platform 130 to receive any packages or parcels when delivered. As one possible type of receiving structure, a receiving box 170 is illustrated, which would be positioned within the building. To accommodate safe handling of various materials, padding 172 may be layered in a portion of receiving box 170. Again, a trapdoor, or door opening structure (not shown) could be easily utilized along with this particular embodiment. It is contemplated that such a door opening structure could be actuated by the delivery vehicle (i.e., drone), or could be operated and controlled by a user. Alternatively, this door could be spring-loaded, thus allowing packages to simply be dropped therethrough, while also providing some level of protection to the outdoor elements.

In a similar manner, a further embodiment is illustrated in FIG. 5, wherein the platform 120 and chute 182 are positioned above a roofline 180, but adjacent to the building or home. Here, a framework 184 is utilized to support platform 120, and position it appropriately. Furthermore, a similar receiving box 186 (having a cushioned or padded layer 188) is positioned below chute 182. Again, trapdoors could be utilized and this embodiment contemplates a drone simply dropping containers or packages.

While particular embodiments of the invention have been shown and described, it will be clear to those skilled in the art that changes and modifications may be made without departing from the invention in its broader aspects, and therefore, the aim in the appended claims is to cover all such changes and modifications as fall within the true spirit and scope of the invention.

The foregoing description is presented to enable one of ordinary skill in the art to make and use the invention and is provided in the context of a patent application and its requirements. Modifications to the preferred embodiment of the apparatus, and the general principles and features of the system and methods described herein will be readily apparent to those of skill in the art. Thus, the present invention is not to be limited to the embodiments of the apparatus, system and methods described above and illustrated in the drawing figures, but is to be accorded the widest scope consistent with the spirit and scope of the appended claims.

1. An delivery support system to accommodate the delivery of items from unmanned aerial vehicles, comprising:
a platform sized to accommodate the operation of an unmanned aerial vehicle;
a support structure coupled to the platform to hold and position the platform at a desired location and orientation away from potentially interfering hazards; and
a handling structure configured to receive the delivered items at the platform and transfer them to a desired transfer location which is accessible by an individual to retrieve the item.

2. The delivery support system of claim 1 wherein the support structure is a free-standing tower like structure for positioning the platform a predetermine distance above the ground.

3. The delivery support system of claim 1 wherein the support structure is a roof mounting structure for attachment to the roof of a building, and thus positioning the platform at a location near the roof.

4. The delivery support structure of claim 1 wherein the support structure is configured to accommodate attachment to the side of a building.

5. The delivery support system of claim 1 wherein the platform further comprises an opening for receiving the item and accommodating the transfer to the handling structure.

6. The delivery support system of claim 5 further comprising a communication system for communicating with the unmanned aerial vehicle to accommodate positioning at a desired location relative to the platform and to provide identification for the platform.

7. The delivery support system of claim 6 wherein the communication system provides guidance to the unmanned aerial vehicle to assist in landing on the platform.

8. The delivery support system of claim 6 wherein the communication system includes RFID tags which are readable by the unmanned aerial vehicle to identify the location and identity of the platform.

9. The delivery support system of claim 1 wherein the platform further includes signal lights to further accommodate communication with the unmanned aerial vehicle.

10. The delivery support system of claim 5 wherein the handling structure comprises an enclosure positioned below the platform and in communication with the opening in the platform, wherein the enclosure is configured to receive the item when delivered and wherein the enclosure is accessible by a user to retrieve the item.

11. The delivery support system of claim 1 wherein the operation of the unmanned aerial vehicle requires landing, and the platform is sized and configured to accommodate this operation.

12. A delivery support structure for accommodating the delivery of an item to a user, which is presented to the support structure by an unmanned aerial vehicle, the delivery support structure comprising:
a platform sized to accommodate the transfer of the item from the unmanned aerial vehicle;
a structure coupled to a base to support and hold the platform at a desired location and orientation away from potentially interfering hazards;
a handling structure configured to receive the delivered items at the platform and transfer them to a desired transfer location which is readily accessible by an individual to retrieve the item; and
a communication system capable of communicating with the unmanned aerial vehicle to provide positioning and identification information.

13. The delivery support structure of claim 12 wherein the platform further includes an opening therein and the handling structure includes a chamber in communication with the opening such that items delivered to the platform can pass through the opening into the chamber for access by the individual; wherein the platform further comprises at least one door mechanism to selectively open and close the opening.

14. The delivery support structure of claim 12 wherein the base is the roof of a building, and the structure is a framework attached to an upper portion of the roof.

15. The delivery support structure of claim 12 wherein the base is the ground, and the structure is free-standing structure supported therein.

16. The delivery support structure of claim 12 wherein the base is a portion of a building and the structure is a framework coupled thereto, thus positioning the platform a predetermined distance away from the building, and wherein the handling structure is configured to transfer items from the platform to within the building.

17. The delivery support structure of claim 12 wherein the communication system is selected from the group comprising; an rf communication system, a wireless network, an infrared communication system, a real-time locating system via steerable phased array antennae, a real-time locating systems, a radio beacon, an ultrasonic identification system, an ultrasonic ranging system, an ultra-wideband system, a Bluetooth system, a cluster in noisy ambience system, or a bivalent system.

18. The delivery support system of claim 12 wherein the platform is sized to accommodate the landing of the unmanned aerial vehicle.
